(19) United States
(12) Patent Application Publication
(10) Pub. No.: US 2023/0394285 A1
(43) Pub. Date: Dec. 7, 2023

(54) DEVICE AND METHOD FOR IMPLEMENTING A TENSOR-TRAIN DECOMPOSITION OPERATION

(71) Applicant: HUAWEI TECHNOLOGIES CO., LTD., Shenzhen (CN)

(72) Inventors: Vladimir Petrovich Korviakov, Moscow (RU); Anuar Guldenbekovich TASKYNOV, Moscow (RU); Jiang Li, Shenzhen (CN); Ivan Leonidovich Mazurenko, Moscow (RU); Yepan Xiong, Hangzhou (CN)

(21) Appl. No.: 18/327,667

(22) Filed: Jun. 1, 2023

Related U.S. Application Data
(63) Continuation of application No. PCT/RU2020/000652, filed on Dec. 1, 2020.

(51) Int. Cl. G06N 3/04

(52) U.S. Cl. CPC G06N 3/0463

(57) ABSTRACT

A device for implementing a tensor-train decomposition operation for a respective convolutional layer of a convolutional neural network (CNN) is provided. The device is configured to receive input data comprising a first number of channels, and perform a 1×1 convolution on the input data to obtain a plurality of data groups. The plurality of data groups comprises a second number of channels. The device is further configured to perform a group convolution on the plurality of data groups to obtain intermediate data comprising a third number of channels, and perform a 1×1 convolution on the intermediate data to obtain output data comprising a fourth number of channels.

### CROSS-REFERENCE TO RELATED APPLICATIONS

This application is a continuation of International Application No. PCT/RU2020/000652, filed on Dec. 1, 2020, the disclosure of which is hereby incorporated by reference in its entirety.

### FIELD

Embodiments of the present disclosure relate to the field of data processing and, particularly, to convolutional neural networks.

### BACKGROUND

Deep learning is a machine learning technique that trains a neural network to perform tasks. The neural network may be a convolutional neural network. For example, the convolutional neural network may learn to perform tasks such as classification tasks related to computer vision, natural language processing, speech recognition, etc.

Conventional convolutional neural networks achieve different accuracies. Moreover, it is desired to find convolutional neural networks that achieve certain accuracies for solving specific problems. However, when using deeper convolutional neural networks, e.g., for further improving the accuracy, these convolutional neural networks may become slower in terms of floating point operations (FLOPs), and may yet become even slower when being operated in a consumer device. For instance, for a convolutional neural network comprising convolutional layers with 512 feature maps, a computation may take up to 115 MFLOPs, so that these convolutional layers may significantly slow down the inference time.

A tensor decomposition is suggested as a technique for reducing computational cost. Tensor decompositions techniques are a class of methods for representing a high dimensional tensor as a sequence of low-cost operations, in order to reduce the number of tensor parameters and to compress data.

A conventional tensor decomposition method may be based on a so-called Tensor-Train decomposition, which is used for data compression, i.e., decreasing a ratio of original tensor size to compressed size.

However, a conventional tensor train decomposition, when being applied to a convolutional layer of a convolutional neural network, still does not overcome all the above issues satisfactory.

### SUMMARY

Embodiments of the present disclosure improve the application of a tensor-train decomposition operation to a convolutional layer of a convolutional neural network (CNN).

Embodiments of the present disclosure reduce the computational complexity of CNNs. Further, embodiments of the present disclosure facilitate a hardware-friendly tensor-train decomposition of a convolutional layer.

Embodiments of the present disclosure enable selection of one or more convolutional layers of the CNN for decomposition, and for example, allow to determine an optimal order of decomposition in the CNN.

Embodiments of the present disclosure thus provide a device and a method enabling an efficient implementation of a tensor-train decomposition operation for a convolutional layer of a CNN.

A first aspect of the present disclosure provides a device for implementing a tensor-train decomposition operation for a convolutional layer of a CNN. The device is configured to receive input data comprising a first number of channels, perform a 1×1 convolution on the input data, to obtain a plurality of data groups, the plurality of data groups comprising a second number of channels, perform a group convolution on the plurality of data groups, to obtain intermediate data comprising a third number of channels, and perform a 1×1 convolution on the intermediate data, to obtain output data comprising a fourth number of channels.

The device may be, or may be incorporated in, an electronic device such as a personal computer, a server computer, a client computer, a laptop and a notebook computer, a tablet device, a mobile phone, a smart phone, a surveillance camera, etc.

The device may be used for implementing a tensor-train decomposition operation for a convolutional layer of a CNN. For example, the device may substitute the convolutional layer of the CNN by a tensor-train operation. The, operation may comprise a compression algorithm for a tensor.

Generally, a tensor may be a multidimensional array comprising a number of elements. For instance, a tensor A may be expressed as follows:

A=(A[i₁,i₂, . . . ,i_{d}]),iₖ∈{1,2, . . . ,nₖ}

Moreover, generally a tensor-train decomposition (TT) of rank r=(r₀, r₁, . . . , r_{d}) of tensor A∈ [symbol] ⁿ^{₁}^{×n}^{₂}^{× . . . ×n}^{_{d}} may be a representation, where each tensor element is a matrix product such as:

$$A [ {i}_{1} , {i}_{2} , … , {i}_{d} ] = \underbrace{{G}_{1} [ {i}_{1} ]}_{1 \times {r}_{1}} \underbrace{{G}_{2} [ {i}_{2} ]}_{{r}_{1} \times {r}_{2}} … \underbrace{{G}_{d} [ {i}_{d} ]}_{{r}_{d - 1} \times 1}$$

where r₀=r_{d}=1. Here, the word “train” may be used to emphasize an analogy with a sequence of train cars.

The CNN is a deep learning neural network, wherein one or more building blocks are based on a convolution operation.

The device may receive the input data (e.g. the input tensor) comprising the first number of channels. The input data may be related to any kind of data, for example, image data, text data, voice data, etc. Furthermore, the device may perform a 1×1 convolution on the input data, and may thereby obtain the plurality of data groups.

For example, the device may perform a convolution operation, which may be, for example, an operation that transforms input feature maps having the first number of channels into output feature maps having the second number of channels, in particular, by convolving the input feature maps with a convolution kernel. An example of a convolution operation, without limiting the present disclosure to this specific example, may be transforming input feature maps X∈ [symbol] ^{W×H×C} (C is input channels) into output feature maps Y∈ [symbol] ^{W-l+1×H-l+1×S} (S is output channels) by convolving with the convolution kernel [symbol] ∈ [symbol] ^{1×l×C×S}:

$$Y [ h , w , s ] = {\sum }_{i} {\sum }_{j} {\sum }_{c} 𝒦 [ i , j , c , s ] X [ h + i - 1 , w + j - 1 , c ] .$$

The device of the first aspect may implement the tensor-train decomposition for a three dimensional convolutional tensor, where kernel size dimensions are combined. For example, the tensor-train decomposition may be applied as follows:

$${𝒦}_{s , c , i , j} = {\sum }_{{r}_{1} , {r}_{2} = 1}^{{R}_{1} , {R}_{2}} {G}_{1}^{1} [ 1 , i , j , {r}_{1} ] {G}^{2} [ {r}_{1} , c , {r}_{2} ] {G}^{3} [ {r}_{2} , s ]$$

Furthermore, the tensor train convolutional layer may be as follows:

$$Y [ h , w , s ] = {\sum }_{c = 1}^{C} {\sum }_{i = 1}^{l} {\sum }_{i = 1}^{l} {\sum }_{{r}_{1} {r}_{2} = 1}^{{R}_{1} {R}_{2}} {G}_{1}^{1} [ 1 , i , j , {r}_{1} ] {G}^{2} [ {r}_{1} , c , {r}_{2} ] {G}^{3} [ {r}_{2} , s ] X [ h + i - 1 , w + j - 1 , c ]$$

Furthermore, the device may obtain the plurality of data groups comprising the second number of channels, the intermediate data comprising the third number of channels, and the output data comprising the fourth number of channels.

The decomposition of the convolutional layer performed by the device may lead to a larger reduction of the computational cost compared to conventional decomposition methods. In particular, the decomposition performed by the device provides acceleration on real hardware. Further, the implementation by the device of the first aspect may take into consideration, which convolutional layer(s) are beneficial to be decomposed, and may further consider a decomposition order of these layers.

In an implementation form of the first aspect, the group convolution is performed based on a shared kernel shared between the plurality of data groups.

In particular, the device may perform group convolution with shared kernel between groups. Further, performing the group convolution based on a shared kernel shared between the plurality of data groups may enable an additional acceleration for tensor train convolution, for example, by adding low-level operations like kernel fusion.

In a further implementation form of the first aspect, the third number of channels is determined based on a number of data groups in the plurality of data groups.

In a further implementation form of the first aspect, the third number of channels is further determined based on one or more hardware characteristics of the device.

For example, the implementation of the tensor-train decomposition operation may be friendly to hardware, and may not require expensive data movement operations and may significantly accelerate inference phase of the CNN. In particular, the device may obtain optimal ranks for the convolutional layers, such that it may be possible to avoid data movements related to reshape operations, permute operations, etc., and may further reach a higher acceleration for processing hardware.

In a further implementation form of the first aspect, each data group comprises a fifth number of channels, and wherein the second number of channels is determined based on the third number of channels and the fifth number of channels.

In a further implementation form of the first aspect, the device is further configured to obtain a CNN comprising a first number of convolutional layers, wherein each convolutional layer is associated with a respective first ranking number, and provide a decomposed CNN comprising a second number of convolutional layers and a third number of decomposed convolutional layers based on a training of the CNN, wherein the first number equals the sum of the second and third numbers, and wherein each decomposed convolutional layer is associated with a respective second ranking number.

For example, the device may obtain a highly optimized convolutions with lower-rank tensor representation, and an optimal order of layers decomposition.

In a further implementation form of the first aspect, the device is further configured to determine, for a convolutional layer of the CNN, a weighting pair calculated based on a weighted convolutional layer obtained by allocating a first weighting trainable parameter to the convolutional layer, and a weighted decomposed convolution layer obtained by allocating a second weighting trainable parameter to a decomposed convolution layer determined for the convolutional layer.

For example, the weighting pair may be op(x, α). Moreover, the first weighting trainable parameter may be “α”, and the second weighting trainable parameter may be “1−α”. The first weighting trainable parameter and/or the second weighting trainable parameter are trainable, i.e., they can be changed in the process of training.

Furthermore, the device may determine the weighting pair op(x, α) for the convolutional layer Conv(x) such that

op(x,α)=α*Conv(x)+(1−α)*DConv(x), where αmay be in range[0,1].

In other words, the convolutional layer may be weighted according to the first weighting trainable parameter “α”, and the decomposed convolution layer is weighted according to the second weighting trainable parameter “1−α”.

In a further implementation form of the first aspect, the device is further configured to perform an initial training iteration of the CNN based on at least one weighting pair.

In a further implementation form of the first aspect, the device is further configured to determine, after performing the initial training iteration, at least one convolutional layer having a minimal first weighting trainable parameter.

In a further implementation form of the first aspect, the device is further configured to perform an additional training iteration of the CNN, based on substituting a weighting pair of the convolutional layer having the minimal first weighting trainable parameter with its decomposed convolution layer, and a remaining of the at least one weighting pair from a previous iteration.

In a further implementation form of the first aspect, the device is further configured to iteratively perform, determining a convolutional layer having a minimal first weighting trainable parameter, substituting the weighting pair of the convolutional layer having the minimal first weighting trainable parameter with its decomposed convolution layer, and performing a next training iteration, until a determined number of convolutional layers are substituted with their respective decomposed convolution layers.

In a further implementation form of the first aspect, the device comprises an artificial intelligence accelerator adapted for tensor processing operation of a CNN.

A second aspect of the disclosure provides a method for implementing a tensor-train decomposition operation for a convolutional layer of a convolutional neural network, wherein the method comprising receiving input data comprising a first number of channels, performing a 1×1 convolution on the input data, to obtain a plurality of data groups, the plurality of data groups comprising a second number of channels, performing a group convolution on the plurality of data groups, to obtain intermediate data comprising a third number of channels, and performing a 1×1 convolution on the intermediate data, to obtain output data comprising a fourth number of channels.

In an implementation form of the second aspect, the group convolution is performed based on a shared kernel shared between the plurality of data groups.

In a further implementation form of the second aspect, the third number of channels is determined based on a number of data groups in the plurality of data groups.

In a further implementation form of the second aspect, the third number of channels is further determined based on one or more hardware characteristics of the device.

In a further implementation form of the second aspect, each data group comprises a fifth number of channels, and wherein the second number of channels is determined based on the third number of channels and the fifth number of channels.

In a further implementation form of the second aspect, the method further comprises obtaining a CNN comprising a first number of convolutional layers, wherein each convolutional layer is associated with a respective first ranking number, and providing a decomposed CNN comprising a second number of convolutional layers and a third number of decomposed convolutional layers based on a training of the CNN, wherein the first number equals the sum of the second and third numbers, and wherein each decomposed convolutional layer is associated with a respective second ranking number.

In a further implementation form of the second aspect, the method further comprises determining, for a convolutional layer of the CNN, a weighting pair calculated based on a weighted convolutional layer obtained by allocating a first weighting trainable parameter to the convolutional layer, and a weighted decomposed convolution layer obtained by allocating a second weighting trainable parameter to a decomposed convolution layer determined for the convolutional layer.

In a further implementation form of the second aspect, the method further comprises performing an initial training iteration of the CNN based on at least one weighting pair.

In a further implementation form of the second aspect, the method further comprises determining, after performing the initial training iteration, at least one convolutional layer having a minimal first weighting trainable parameter.

In a further implementation form of the second aspect, the method further comprises performing an additional training iteration of the CNN, based on substituting a weighting pair of the convolutional layer having the minimal first weighting trainable parameter with its decomposed convolution layer, and a remaining of the at least one weighting pair from a previous iteration.

In a further implementation form of the second aspect, the method further comprises iteratively performing, determining a convolutional layer having a minimal first weighting trainable parameter, substituting the weighting pair of the convolutional layer having the minimal first weighting trainable parameter with its decomposed convolution layer, and performing a next training iteration, until a determined number of convolutional layers are substituted with their respective decomposed convolution layers.

In a further implementation form of the second aspect, the method is for a device comprising an artificial intelligence accelerator adapted for tensor processing operation of a CNN.

The method of the third aspect achieves the advantages and effects described for the transmitter device of the first aspect.

A third aspect of the present disclosure provides a computer program comprising a program code for performing the method according to the second aspect or any of its implementation forms.

A fourth aspect of the present disclosure provides a non-transitory storage medium storing executable program code which, when executed by a processor, causes the method according to the second aspect or any of its implementation forms to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 illustrates a device for implementing a tensor-train decomposition operation for a convolutional layer of a CNN, according to an embodiment;

FIG. 2 illustrates a tensor-train decomposition for a three dimensional convolutional tensor according an embodiment;

FIG. 3 illustrates performing a 1×1 convolution according to an embodiment;

FIG. 4 illustrates a flowchart of a method for a tensor train decomposition operation according to an embodiment;

FIG. 5 illustrates a flowchart of a method for obtaining a decomposed CNN based on a training of a CNN according to an embodiment;

FIG. 6 illustrates replacing convolutional layers to weighted convolutions according to an embodiment;

FIG. 7 illustrates substituting a weighting pair of a convolutional layer with its decomposed convolution layer according to an embodiment;

FIG. 8 illustrates changing a set of weighting pairs with their corresponding convolutional layers according to an embodiment; and

FIG. 9 illustrates a flowchart of a method for implementing a tensor-train decomposition operation for a convolutional layer of a convolutional neural network, according to an embodiment.

### DETAILED DESCRIPTION

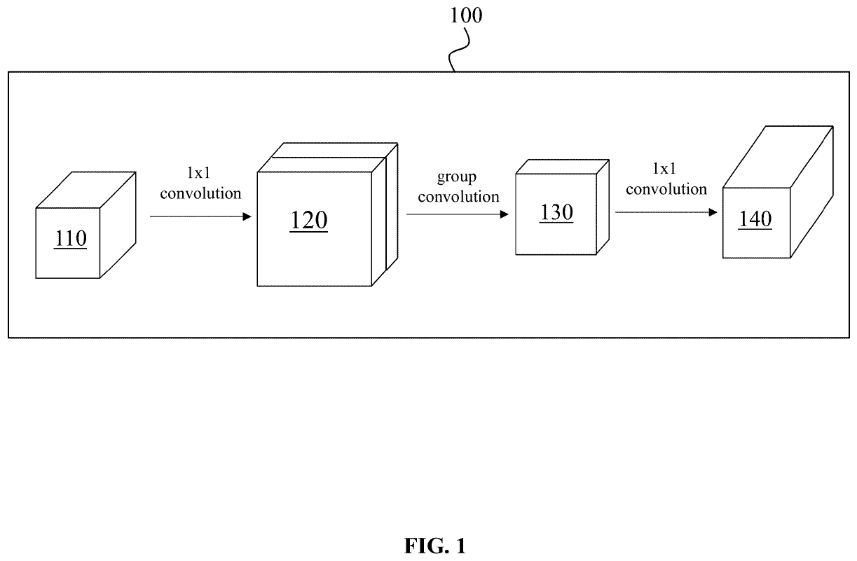

FIG. 1 shows a device 100 for implementing a tensor-train decomposition operation for a convolutional layer of a CNN, according to an embodiment of the disclosure.

The device 100 may be an electronic device such as a computer, a personal computer, a smartphone, surveillance camera, etc.

The device 100 is configured to receive input data 110 comprising a first number of channels.

The device 100 is further configured to perform a 1×1 convolution on the input data 110, to obtain a plurality of data groups 120. The plurality of data groups 120 comprise a second number of channels.

The device 100 is further configured to perform a group convolution on the plurality of data groups 120, to obtain intermediate data 130. The intermediate data 130 comprises a third number of channels.

The device 100 is further configured to perform a 1×1 convolution on the intermediate data 130, to obtain output data 140. The output data 140 comprises a fourth number of channels.

The device 100 may implement the tensor train convolution operation for the convolutional layer of the CNN.

The device 100 may increase the accurate tuning and may enable additional acceleration on real hardware, for example, by not using different ranks for tensor-train cores such acceleration may be achieved.

For example, the device 100 may perform a sequence of a 1×1 convolution, a group convolution with shared weights and another 1×1 convolution, for a hardware-friendly Tensor-train decomposition implementation. Moreover, by using weight sharing in the group convolution, the device 100 may enable an additional acceleration on real hardware due to weights reuse and reduced data transfer, and may avoid time-consuming permute and reshape operations, etc.

The device 100 may comprise processing circuitry (not shown in FIG. 1) configured to perform, conduct or initiate the various operations of the device 100 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the device 100 to perform, conduct or initiate the operations or methods described herein.

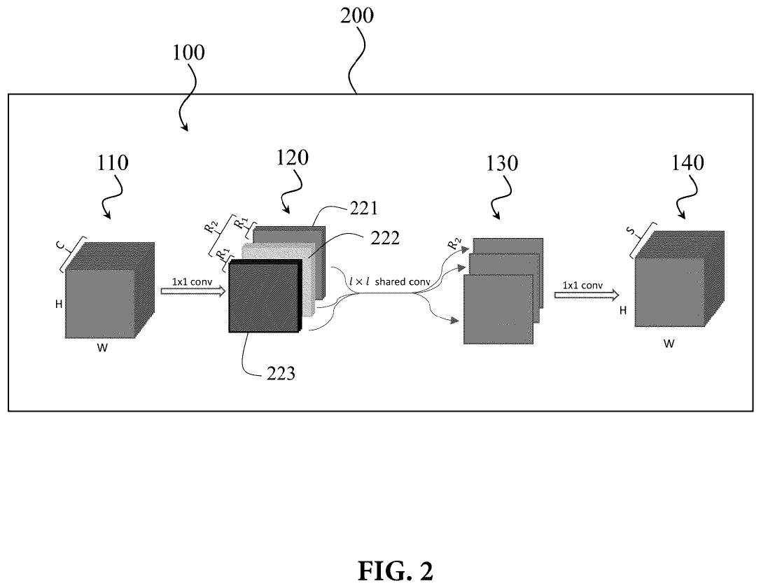

FIG. 2 shows a schematically a procedure of performing of a tensor-train decomposition for a three dimensional convolutional tensor. For example, the device 100 may perform the illustrated tensor-train decomposition for the three dimensional convolutional tensor.

The device 100 may, in particular, receive the input data 110 comprising C channels (first number of channels).

The device 100 may further perform a 1×1 convolution from the C channels to R₁R₂ channels. For example, the device 100 may perform a 1×1 convolution on the input data 110, to obtain a plurality of data groups 120 comprising a second number of channels. In the diagram of FIG. 2, the second number of channels is R₁R₂.

The device 100 may further perform a l×l group convolution on the plurality of data groups 120, having R₁R₂ channels, to obtain the intermediate data 130 having R₂ channels (the third number of channels). For example, the device 100 may perform the group convolution with a shared kernel weight. In the diagram 200 of FIG. 2, the plurality of data groups 120 comprise three data group 221, 222, 223, and the group convolution is performed based on the shared kernel shared between the data groups 221, 222, 223.

The device 100 may further perform the 1×1 convolution from the R₂ channels to S channels. For example, the device 100 may perform the 1×1 convolution on the intermediate data 130, to obtain output data 140 comprising S channels (the fourth number of channels).

In the diagram 200 of FIG. 2, the tensor train decomposition operation is represented as a three convolutions, wherein the second convolution is a group convolution with shared kernel weights.

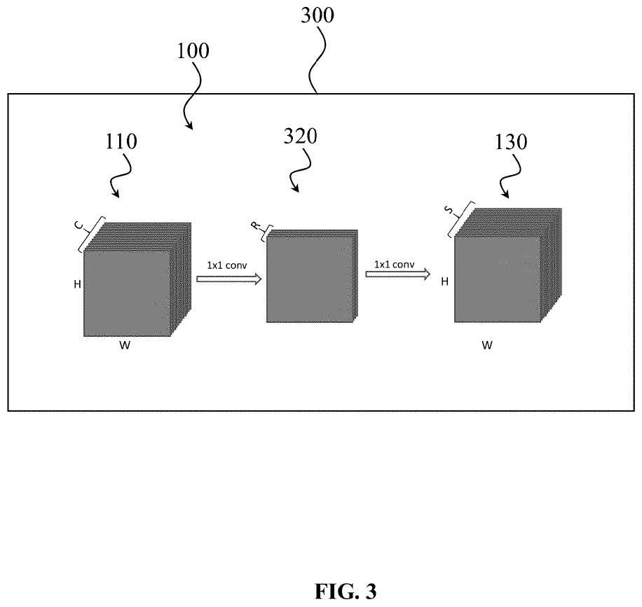

FIG. 3 shows schematically a procedure of performing of a 1×1 convolution.

The diagram 300 of FIG. 3 is an exemplary illustration, in which the device 100 may perform a first 1×1 convolution on input data 110 comprising the C number of channels, to obtain data group 320 comprising R channels (a second number of channels).

The device 100 may further perform a second 1×1 convolution on the data group 320, to obtain output data comprising S channel (the fourth number of channels). An example of the tensor train decomposition operation may be as follows:

$$Y [ h , w , s ] = {\sum }_{c = 1}^{C} {\sum }_{r = 1}^{R} {G}^{1} [ c , r ] {G}^{2} [ r , s ] X [ h , w , c ]$$

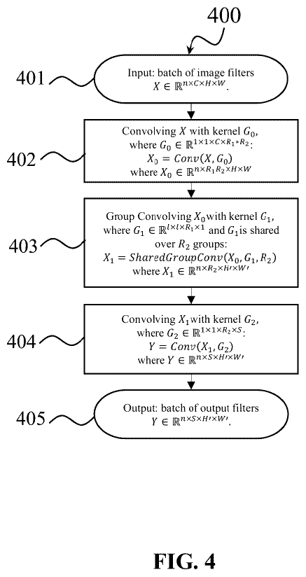

FIG. 4 shows a flowchart of a method 400 for a tensor-train decomposition operation. The method 400 may be performed by the device 100, as it is described above.

At step 401, the device 100 may obtain the input data 110. The input data 110 may comprise a batch of image filters X∈ [symbol] ^{n×C×H×W}.

At step 402, the device 100 may perform a 1×1 convolution on the input data 110. For example, the device 100 may convolve X with a kernel G₀, wherein G₀∈ [symbol] ^{1×1×C×R}^{₁}*^{R}^{₂}, and the device 100 may further may obtain X₀=Conv(X, G₀), wherein X₀∈ [symbol] ^{n×R}^{₁}^{R}^{₂}^{×H×W}.

At step 403, the device 100 may perform a group convolution. For example, the device 100 may group-convolve X₀ with a kernel G₁, wherein G₁∈ [symbol] ^{l×l×R}^{₁}^{×1}, and G₁ is shared over R₂ groups. The device 100 may further obtain X₁ as follows:

X₁=SharedGroupConv(X₀,G₁,R₂), where X₁∈ [symbol] ^{n×R}^{₂}^{×H′×W′}.

At step 404, the device 100 may convolve X₁ with a kernel G₂, wherein G₂∈ [symbol] ^{1×1×R}^{₂}^{×S}. The device 100 may further obtain Y=Conv(X₁, G₂), where Y∈ [symbol] ^{n×S×H′×W′}.

At step 405, the device 100 may obtain the output data 140. The output data 140 may be a batch of output filters, wherein Y∈ [symbol] ^{n×S×H′×W′}.

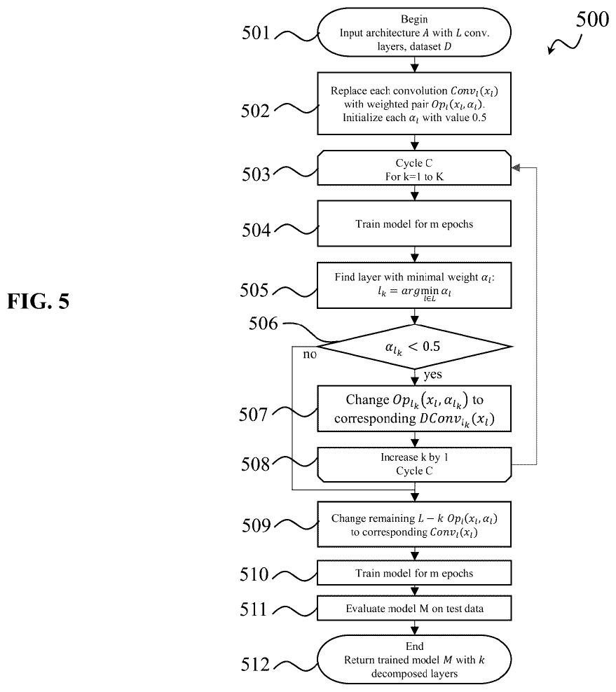

Reference is now made to FIG. 5, which shows a flowchart of a method 500 for obtaining decomposed convolutional layers of a CNN. The method 500 may be performed by the device 100, as it is described above.

At step 501, the device may obtain a CNN comprising a first number (L) of convolutional layers. For example, the device 100 may receive the input architecture A with L convolutional layers in the data set D.

At step 502, the device 100 may replace each convolution layer Convₗ(xₗ) with a weighted pair Opₗ(xₗ, αₗ). The device 100 may further initialize each αₗ with the value of 0.5.

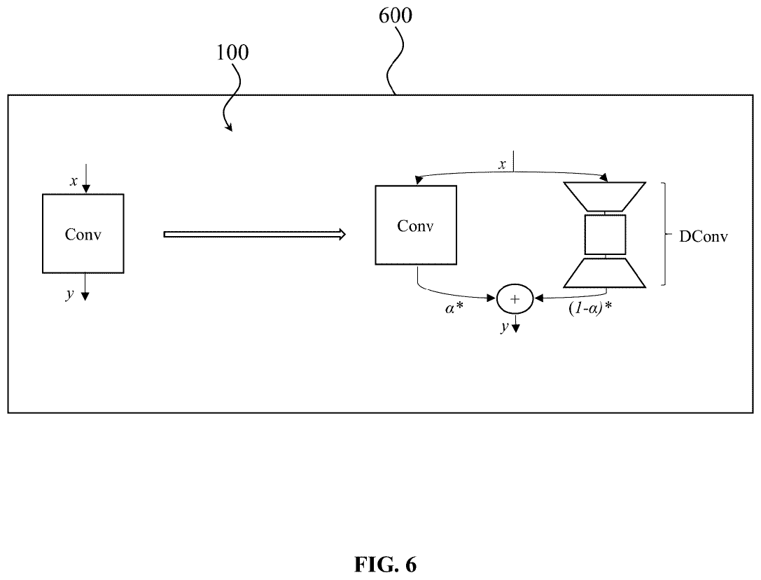

An exemplarily illustration of replacing convolutional layers with weighted convolutions is shown in the diagram 600 of FIG. 6. The diagram 600 of FIG. 6 illustrates, for example, that the device 100 may replace all L convolutional layers with weighted convolutions.

At step 503, the device 100 may cycle C, for k=1 to k=K.

At step 504, the device 100 may train the CNN with this op(x) instead of usual convolution over m epochs. For example, the device 100 may perform an initial training iteration of the CNN A based on at least one weighting pair op(x, α) and at least one weighted convolutional layer α*Conv(x).

At step 505, the device 100 may determine, after performing the initial training iteration, a convolutional layer Conv(x) having a minimal weighting parameter α. For example, the device 100 may find a convolutional layer with minimal weight αₗ according to:

$${l}_{k} = arg {min}_{l ∈ L} {α}_{l}$$

At step 506, the device 100 may determine, whether αₗ_{ₖ}<0.5. Moreover, when the device 100 determines “Yes”, the device 100 goes to step 507, and when it determines “No”, the device 100 returns to step 509.

At step 507, the device 100 may substitute the weighting pair op(x, α) of the convolutional layer Conv(x) having the minimal weighting parameter α with its decomposed convolution layer DConv(x).

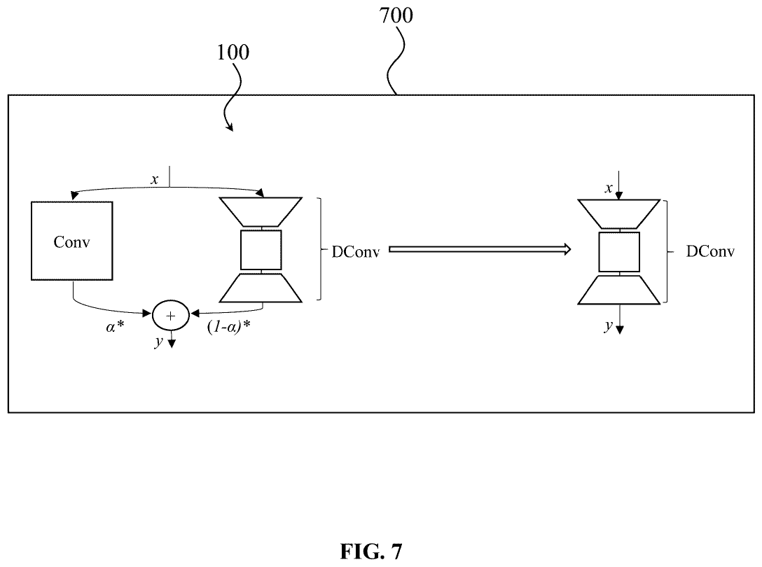

An exemplarily illustration substituting a weighting pair of a convolutional layer with its decomposed convolution is shown in the diagram 700 of FIG. 7. The diagram 700 of FIG. 7 illustrates, for example, the device 100 changing Opₗ_{ₖ} (xₗ, αₗ_{ₖ}) to corresponding DConvₗ_{ₖ}(xₗ).

At step 508, the device 100 may increase k by 1, and may further return to step 503 K times. (for example, K=10)

At step 509, the device 100 may change the remaining L−k Opₗ(xₗ, αₗ) to a corresponding convolutional layer Convₗ(xₗ).

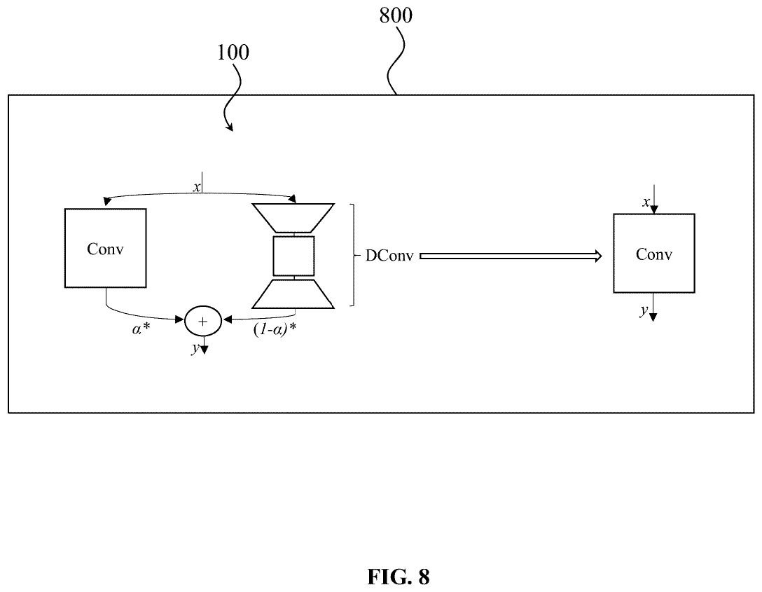

An exemplarily illustration of changing a set of weighting pairs with their corresponding convolutional layers is illustrated in FIG. 8. For example, the device 100 may obtain the training loss based on determining the cross-entropy according to:

$$ℒ ( D ) = - {\sum }_{x , y ∼ D} log \frac{{e}^{n e {t ( x )}_{y}}}{{\sum }_{j = 1}^{c} {e}^{n e {t ( x )}_{j}}}$$

where net(x) is a neural network's output, D—data of training examples (x, y).

At step 510, the device 100 may train the model for m epochs. For example, the device 100 may perform an additional training iteration of the CNN A, based on substituting a weighting pair op(x, α) of the convolutional layer Conv(x) having the minimal weighting parameter α with its decomposed convolution layer DConv(x), a remaining of the at least one weighting pair op(x, α)) and a remaining of the at least one weighted convolutional layer α*Conv(x) from a previous iteration.

At step 511, the device 100 may evaluate a model M on test data.

At step 512, the device 100 may return trained model M with k decomposed layers. For example, the device 100 may obtain the decomposed CNN M comprising the second number of convolutional layers and a third number k of decomposed convolutional layers.

In the following, an example of the performance of the device 100 is discussed, without limiting the present discourse to this specific example.

At first, the device 100 selects the ranks R₁, R₂ for 3×3 convolutional layer, and R for the 1×1 convolution.

The device 100 may perform matrix multiplication operations. For example, the device 100 may split large matrices to parts of predefined size (e.g., 16, but any device-specific number can be used), and may further perform multiplication operation part-by-part. Furthermore, if channel number is not divisible by 16, channels may be padded with zeros until their number is divisible by 16.

The device 100 may further use R 2=16, because the last convolution in the tensor train convolution operates with this channel number, and for R₁=S/(4*R₂). So, the device 100 may use the following condition:

$${R}_{1} * {R}_{2} = \frac{S}{4}$$

For example, if C=512, S=512, l=3:
The first convolution is a mapping from 512 channels to 128 channels.
The second convolution is a 3×3 group convolution from 128 channels to 16 channels, where number of groups is 16. So in this convolution, the device 100 shares 3×3×8×1 shape weight between 16 groups.
The last convolution is a mapping from 16 channels to 512 channels.

Furthermore, a comparison of a total number of floating point operations of obtained by the device 100 and some conventional devices, respectively, is presented, without limiting the present disclosure. The following notation are thereby used: N is a batch size, C is a number of input channels, S is the number of output channels, l is the kernel size, R₁, . . . , R_{d} are original tensor-train decomposition operation (TTConv) ranks, R₁, R₂ are related to the TTConv ranks obtained by the device 100, R is the TRConv (tensor-ring convolution) rank obtained by conventional devices.

| | FLOP (computation) | FLOP (data transfer) |
|---|---|---|
| Usual Conv | NHWl²CS | NHW(C + S) |
| Original TTConv | $N H W ( C {l}^{2} {R}_{1} + {\sum }_{k = 1}^{d} {R}_{k} {R}_{k + 1} {\prod }_{m \geq k} {C}_{m} {\prod }_{m \leq k} {S}_{m} )$ | $NHW ( 3 C + 7 C {R}_{1} + {\sum }_{k = 1}^{d} {\prod }_{m > k} {C}_{m} {\prod }_{m < k} {S}_{m} ( 3 {R}_{k} {C}_{k} + 5 {R}_{k + 1} {S}_{k} ) + 4 S )$ |
| TRConv | NHW(R²C + R³l² + R²S) | NHW(C + 4R² + S) |
| Device 100 | NHW(R₁R₂C + R₁R₂l² + R₂S) | NHW(C + 2R₁R₂ + 2R₂ + S) |

Some examples (for convenienceN=1, l=3):

| | | | | FLOP | FLOP (data | FLOP |
|---|---|---|---|---|---|---|
| | H, W | ranks | C,S | (computation) | transfer) | (total) |
| Usual Conv | 7, 7 | — | 512, 512 | 115.6M | 0.05M | 116M |
| Original | 7, 7 | R₁ = R₂ = | C₁ = C₂ = | 10.5M | 3.2M | 13.7M |
| TTConv | | R₃ = 4; | C₃ = 8; | | | |
| | | | S₁ = S₂ = | | | |
| | | | S₃ = 8; | | | |
| TRConv | 7, 7 | R = 16 | 512, 512 | 14.6M | 0.1M | 14.7M |
| Device 100 | 7, 7 | R₁ = 8, R₂ = 16 | 512, 512 | 3.7M | 0.064M | 3.8M |
| Usual Conv | 14, 14 | — | 256, 256 | 115.6M | 0.1M | 115.7M |
| Original | 14, 14 | R₁ = R₂ = | C₁ = C₂ = 8, | 4.9M | 3.5M | 8.4M |
| TTConv | | R₃ = 2; | C₃ = 4; | | | |
| | | | S₁ = S₂ = 8, | | | |
| | | | S₃ = 4; | | | |
| TRConv | 14, 14 | R = 8 | 256, 256 | 7.3M | 0.15M | 7.4M |
| Device 100 | 14, 14 | R₁ = 4, R₂ = 16 | 256, 256 | 4.1M | 0.13M | 4.23M |

Next, a comparison of the results obtained by the device 100 (based on performing the tensor train decomposition operation TTConv) with the previous implementation on object detection task is presented. A YOLO-based model is used, and the last three layers are decomposed in the following procedure:
Converting last three convolutional layers from a pertained model to TTConv using TT-SVD algorithm with fixed ranks. One of the convolutions has C=256 and S=512 channels, and other two convolutions have has C=512 and S=512 channels, respectively.
Training this model with three TTConv layers.
Inference time has been measured by the device 100.

Results show that using the device 100 (implementing the tensor train decomposition operation or the TTConv) is more justified than original operation.

| | | Pedestrian | Inference |
|---|---|---|---|
| Model | Face AP | AP | (bs = 16), ms |
| YOLO-baseline | 85.1 | 88.9 | 3.175 |
| YOLO-TTConv base | 85.4 | 88.1 | 70 |
| YOLO-TTConv our | 85.7 | 88.6 | 2.963(−6.7%) |

At next, the inference improvement is computed for individual layers using the device 100. This layers are part of ResNet50 backbone model. Further, the original convolutional layer is compared with the result obtained by the device 100.

| | | Usual Conv | Our TTConv |
|---|---|---|---|
| C, S | 1, stride (s) | inference | inference |
| 256, 512 | l = 1, s = 2 | 0.046 ms | 0.033 ms (−28%) |
| 512, 512 | l = 3, s = 1 | 0.059 ms | 0.03 ms (−47%) |
| 512, 512 | l = 3, s = 2 | 0.058 ms | 0.32 ms (−45%) |
| 512, 2048 | l = 1, s = 1 | 0.042 ms | 0.023 ms (−45%) |
| 1024, 2048 | l = 1, s = 2 | 0.056 ms | 0.023 ms (−59%) |

The results show that using TTConv accelerate individual convolutional layer in real device. So it may be concluded that the TTConv performed by the device 100 is hardware-friendly.

Moreover, the training operation performed by the device 100 may also improve the model quality. For example, ResNet34 is chosen as a model which has a good quality on ImageNet dataset. ResNet models comprise four 4 stages, where number of channels grow with stage, in case of ResNet34, the fourth stage comprises only 512 channel convolutions.

| stages | model | TOP1 (accuracy) | Inference, ms |
|---|---|---|---|
| — | ResNet34 (baseline) | 73.36 | 1.15 |
| 4 | ResNet34_stage | 71.06 | 0.95 (−17.5%) |
| | ResNet34_auto | 72.16 | 0.98 (−15%) |
| 3, 4 | ResNet34_stage | 64.5 | 0.702 (−39%) |
| | ResNet34_auto | 73.07 | 0.957 (−17%) |
| 2, 3, 4 | ResNet34_stage | 60.32 | 0.601 (−48%) |
| | ResNet34_auto | 73.44 | 1.01 (−12%) |
| all stages | ResNet34_stage | 58.77 | 0.699 (−39%) |
| | ResNet34_auto | 72.89 | 0.977 (−15%) |

As ResNet34 stage, the device 100 uses a model, where all convolutions in these stages are replaced by TTConv, and the ResNet34_auto—model, where all convolutions in these stages are replaced by op (x, α) and are trained by our training procedure.

Furthermore, it may be concluded that using proposed TTConv improves model inference, for example, as it can be derived from the data presented on the last column. Furthermore, it may be concluded that using the training performed by the device 100, the optimal layers may be determined.

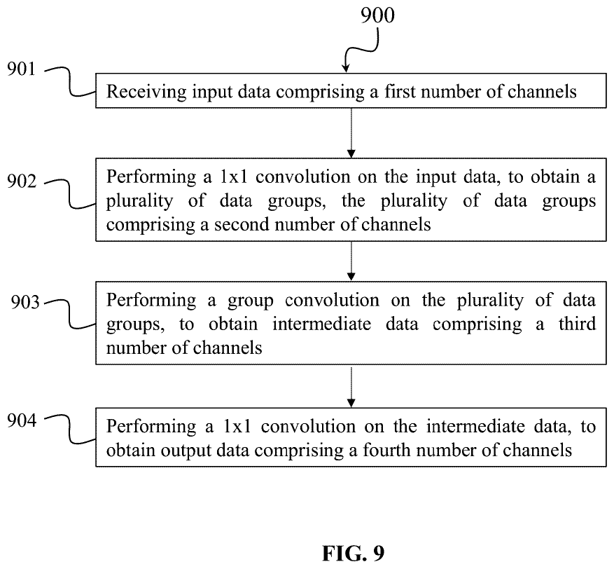

FIG. 9 shows a method 900 according to an embodiment of the disclosure for implementing a tensor-train decomposition operation for a convolutional layer of a convolutional neural network. The method 900 may be carried out by the device 100, as it is described above.

The method 900 comprises a step 901 of receiving input data 110 comprising a first number of channels.

The method 900 further comprises a step 902 of performing a 1×1 convolution on the input data 110, to obtain a plurality of data groups 120, the plurality of data groups 120 comprising a second number of channels.

The method 900 further comprises a step 903 of performing a group convolution on the plurality of data groups 120, to obtain intermediate data 130 comprising a third number of channels.

The method 900 further comprises a step 904 of performing a 1×1 convolution on the intermediate data 130, to obtain output data 140 comprising a fourth number of channels.

The present disclosure has been described in conjunction with various embodiments as examples as well as implementations. However, other variations can be understood and effected by those persons skilled in the art and practicing the claimed disclosure, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A device for implementing a tensor-train decomposition operation for a respective convolutional layer of a convolutional neural network (CNN), the device being configured to:
receive input data comprising a first number of channels;
perform a 1×1 convolution on the input data, to obtain a plurality of data groups, the plurality of data groups comprising a second number of channels;
perform a group convolution on the plurality of data groups, to obtain intermediate data comprising a third number of channels; and
perform a 1×1 convolution on the intermediate data, to obtain output data comprising a fourth number of channels.

2. The device according to claim 1, wherein:
the group convolution is performed based on a kernel shared between the plurality of data groups.

3. The device according to claim 1, wherein:
the third number of channels is determined based on a number of data groups in the plurality of data groups.

4. The device according to claim 3, wherein:
the third number of channels is further determined based on one or more hardware characteristics of the device.

5. The device according to claim 1, wherein:
each data group comprises a fifth number of channels, and wherein the second number of channels is determined based on the third number of channels and the fifth number of channels.

6. The device according to claim 1, further configured to:
obtain the CNN comprising a first number of convolutional layers, wherein each convolutional layer is associated with a respective first ranking number; and
provide a decomposed CNN comprising a second number of convolutional layers and a third number of decomposed convolutional layers based on a training of the CNN,
wherein the first number of convolutional layers equals a sum of the second number of convolutional layers and the third number of decomposed convolutional layers, and wherein each decomposed convolutional layer is associated with a respective second ranking number.

7. The device according to claim 6, further configured to determine, for a respective convolutional layer of the CNN, a weighting pair based on:
a weighted convolutional layer obtained by allocating a first weighting trainable parameter to the respective convolutional layer; and
a weighted decomposed convolution layer obtained by allocating a second weighting trainable parameter to a decomposed convolution layer determined for the respective convolutional layer.

8. The device according to claim 7, further configured to:
perform an initial training iteration of the CNN based on at least one the weighting pair.

9. The device according to claim 8, further configured to:
determine, after performing the initial training iteration, at least one convolutional layer having a minimal first weighting trainable parameter.

10. The device according to claim 9, further configured to:
perform an additional training iteration of the CNN, based on substituting a weighting pair of the at least one convolutional layer having the minimal first weighting trainable parameter with a corresponding decomposed convolution layer, and a remaining of the at least one weighting pair from a previous iteration.

11. The device according to claim 8, further configured to:
iteratively perform, determining a respective convolutional layer having a minimal first weighting trainable parameter, substituting the weighting pair of the respective convolutional layer having the minimal first weighting trainable parameter with a corresponding decomposed convolution layer, and performing a next training iteration, until a predetermined number of convolutional layers are substituted with corresponding decomposed convolution layers.

12. The device according to claim 11,
comprising an artificial intelligence accelerator adapted for tensor processing operation of the CNN.

13. A method for implementing a tensor-train decomposition operation for a convolutional layer of a convolutional neural network (CNN), the method comprising:
receiving input data comprising a first number of channels;
performing a 1×1 convolution on the input data to obtain a plurality of data groups, the plurality of data groups comprising a second number of channels;
performing a group convolution on the plurality of data groups, to obtain intermediate data comprising a third number of channels; and
performing a 1×1 convolution on the intermediate data, to obtain output data comprising a fourth number of channels.

14. A tangible, non-transitory computer-readable medium having instructions thereon, which, upon being executed by a computer, cause the steps of the method of claim 13 to be performed.

15. The method according to claim 13, wherein the group convolution is performed based on a kernel shared between the plurality of data groups.

16. The method according to claim 13, wherein the third number of channels is determined based on a number of data groups in the plurality of data groups.

17. The method according to claim 16, wherein the third number of channels is further determined based on one or more hardware characteristics of the device.

18. The method according to claim 13, wherein each data group comprises a fifth number of channels, and wherein the second number of channels is determined based on the third number of channels and the fifth number of channels.
